(19) United States
(12) Patent Application Publication
(10) Pub. No.: US 2024/0369971 A1
(43) Pub. Date: Nov. 7, 2024

(54) INERTIA ELEMENT FOR A CLOCK MOVEMENT

(71) Applicant: ROLEX SA, Geneva (CH)

(72) Inventor: Raoul Behrend, Nyon (CH)

(73) Assignee: ROLEX SA, Geneva (CH)

(21) Appl. No.: 18/689,152

(22) PCT Filed: Sep. 9, 2022
(86) PCT No.: PCT/EP2022/075097

§ 371 Date: Mar. 19, 2024

(30) Foreign Application Priority Data
Sep. 9, 2021 (EP) 21195769.1

(51) Int. Cl. G04B 17/06; G04B 15/14

(52) U.S. Cl. CPC G04B 17/06; G04B 15/14

(57) ABSTRACT

An inertial element (1), in particular a balance wheel (1), for a timepiece movement (200), the inertial element including a felloe (11) made of or including a first material which is paramagnetic or diamagnetic, and which has an electrical resistivity of greater than 15 μΩ×cm, preferably greater than 20 μΩ×cm.

The invention relates to an inertial element, in particular a balance wheel, for a timepiece movement. The invention also relates to an oscillator comprising such an inertial element. The invention further relates to a regulating system comprising such an oscillator or such an inertial element. The invention further relates to a timepiece movement comprising such an oscillator or such an inertial element or such a regulating system. The invention lastly relates to a timepiece comprising such a timepiece movement or such an oscillator or such an inertial element or such a regulating system.

The book “Théorie d'horlogerie” [Watchmaking theory], edited by la Fédération des Ecoles Techniques [the Federation of Technical Schools], C.-A. Reymondin et al. mentions that the NIHS standard (NIHS-90-10) specifies that, for magnetic resistant watches commonly used, a watch must not stop in a magnetic field of 4800 A/m (60 G) and must have a residual effect that does not exceed 30 seconds per day (for a fitting diameter of more than 20 mm). For special watches, it is recommended to solve the problem of magnetism by enclosing the movement in a magnetic screen made of mu-metal, of permalloy, or of soft iron. However, such a solution presents numerous size, design and esthetics constraints.

Document CH716862 describes a timepiece movement and mentions stoppages at magnetic field values of greater than 3000 G, or even 4000 G, via the combination of an “amagnetic” hairspring and “amagnetic” metal staffs of the regulating member.

Document EP2979139 proposes a specific structure of a balance staff (a magnetically inhomogeneous monobloc staff exhibiting non-uniform, intrinsic magnetic properties in its volume) making it possible for watches having a hairspring, a pallet body and an escapement wheel that are amagnetic to resist magnetic fields of about 1 T (10 000 G) without stopping, and without impairing the mechanical performance (chronometry and aging of the mobiles).

Document EP2757423 relates to staffs that have been surface-hardened by a thermal treatment under a controlled atmosphere. Paragraph [0010] specifies that: “the aim of the present invention is [ . . . ] to propose a pivot staff making it possible both to limit sensitivity to magnetic fields and to obtain improved durability compatible with wear resistance and shock resistance requirements in the field of horology”. However, there is no mention of stoppage of the movement under any magnetic field in said document.

Document EP3258325 relates to staffs made from ceramic material that offer the advantage of being amagnetic and of not influencing the operation of the timepiece when it is subjected to a magnetic field, in particular a magnetic field of greater than 32 kA/m (400 G).

The aim of the invention is to provide an inertial element making it possible to improve the known timepiece devices of the prior art and to solve the problems mentioned. In particular, the invention proposes an inertial element making it possible for a timepiece movement to function without stopping under an intense magnetic field, in particular a magnetic field with an intensity of 8000 G, or even 15 000 G, or even 20 000 G, or even 30 000 G, while still ensuring residual effect of less than 1 second per day after such exposure.

According to the invention, an inertial element is defined by claim 1.

Embodiments of the inertial element are defined by claims 2 to 10.

According to the invention, an oscillator is defined by claim 11.

According to the invention, a regulating system is defined by claim 12 or 13.

According to the invention, a use is defined by claim 14.

According to the invention, a timepiece movement is defined by claim 15 or 16.

According to the invention, a timepiece is defined by claim 17 or 18.

The appended drawings show, by way of example, an embodiment of a timepiece, in particular an embodiment of a regulating system.

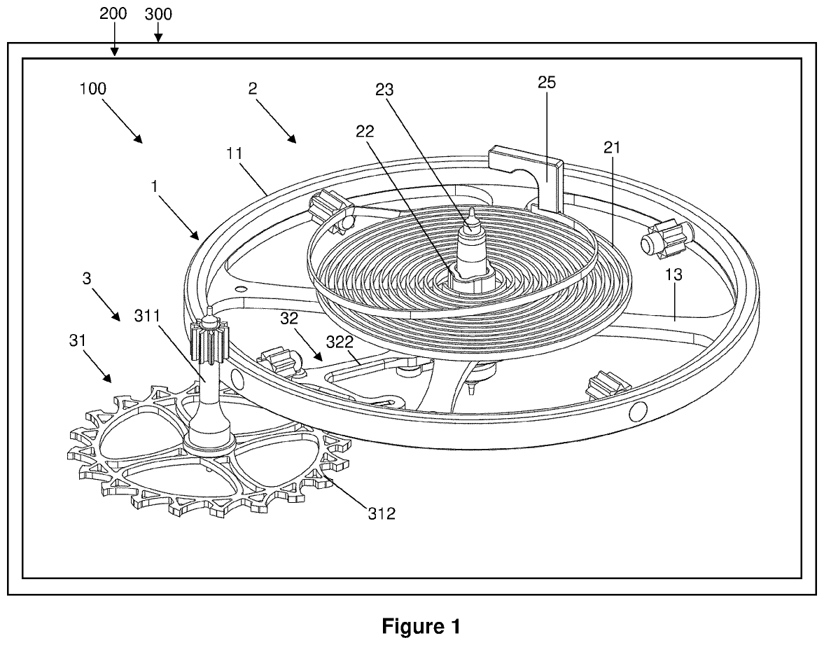

FIG. 1 is a perspective view of an embodiment of a timepiece.

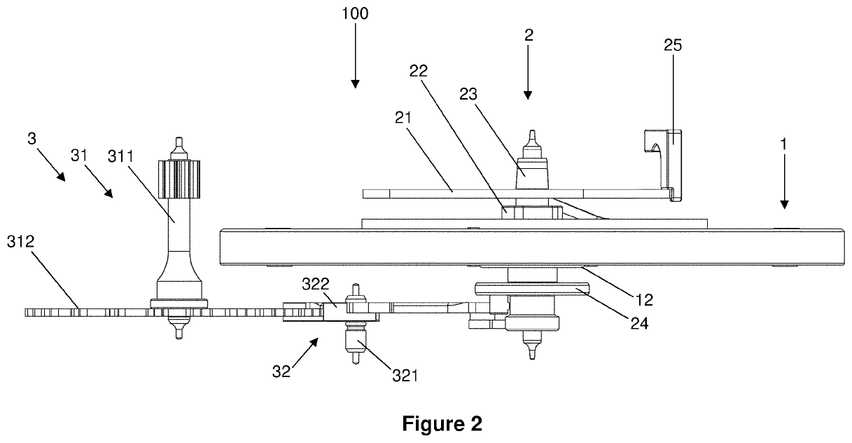

FIG. 2 is a side view of the embodiment of the regulating system of the timepiece of FIG. 1.

An embodiment of a timepiece 300 is described below in detail with reference to FIGS. 1 and 2. The timepiece 300 is for example a watch, in particular a wristwatch. The timepiece 300 comprises a timepiece movement 200 intended to be mounted in a timepiece casing or case in order to protect it from the external environment. The timepiece movement 200 may be a mechanical movement, in particular an automatic movement, or a hybrid movement.

The timepiece movement 200 comprises a regulating system 100.

The regulating system 100 comprises an oscillator 2 and an escapement system 3.

The oscillator 2 comprises an inertial element 1.

In the case of a traditional oscillator (as shown in FIGS. 1 and 2), the oscillator also comprises a hairspring 21 and the inertial element 1 is a balance wheel 1 pivoted on a frame of the timepiece movement.

The inertial element comprises a felloe 11, made of a first material or comprising a first material. The first material:
is paramagnetic or diamagnetic, and
has an electrical resistivity of greater than 15 μΩ×cm, preferably greater than 20 μΩ×cm.

Advantageously, the first material is a metallic material and has an electrical resistivity of less than 100 μΩ×cm or less than 200 μΩ×cm or less than 1000 μΩ×cm.

Further advantageously, the first material has an electrical resistivity of between 100 μΩ×cm and 10³ μΩ×cm or between 10¹³ μΩ×cm and 10¹³ μΩ×cm or of greater than 10¹³ μΩ×cm.

Apart from the felloe 11, the inertial element 1 comprises:
a hub 12, and/or
arms 13.

One or more of these elements preferably comprises the first material or is preferably formed by the first material. Advantageously, the felloe, the hub and the arms are in one piece or made as a single piece and are therefore formed by the same first material.

The hub 12 preferably comprises a bore for receiving an inertial element staff 23 making it possible to pivot the inertial element 1 on the frame of the timepiece movement.

The arms 13 make it possible to mechanically link the hub 12 to the felloe 11. The arms preferably have an elongate shape. In particular, the arms extend radially or substantially radially relative to the staff 23. The arms may be replaced by any other element making it possible to mechanically link or to fix the hub 12 to the felloe 11, such as a support, for example. Such a support may be solid, i.e. it cannot be passed through in an axial direction parallel to that of the staff 23, that is to say that it does not comprise any apertures passing through it. As an alternative, such a support may be apertured, i.e. it comprises apertures passing through it. In a particular implementation of the inertial element, the support may in particular exhibit a disk shape.

In a particular implementation of the inertial element, the support may act as hub and thus be coincident with the hub. As an alternative or in addition, the felloe may act as support or be coincident with the support, thus forming a solid or apertured disk. In this way, the support, the hub and/or the felloe may be made of the first material or comprise the first material. In particular, the hub, the support and the felloe may be in one piece. As a further alternative, the inertial element may comprise a disk with:
the hub,
the support, and
the felloe
   in one piece.

Advantageously, the first material is:
CuAl7Si2, or
CuNi15Sn8, or
lead-free brass (notably CuZn21Si3P), or
NiP, or
titanium or titanium alloy, or
Co40Cr20Ni16Mo7 (Phynox), or
ceramic such as ZrO₂ or Al₂O₃, or
silicon, or
ruby, or
glass.

The felloe 11 preferably has a continuous shape (i.e. it is possible to make a complete turn around the axis 23 while remaining in the material forming the felloe), in particular a continuous annular shape as illustrated in FIGS. 1 and 2. Advantageously, the felloe of continuous shape, in particular of continuous annular shape, is formed of a single material, preferably of a single conductive material such as a metal alloy with high electrical resistivity (for example an electrical resistivity greater than 20 μΩ×cm). Alternatively, the inertial element 1, in particular the felloe 11, may comprise multiple portions made of different materials, in particular semiconductor materials or electrical insulators. Each of these materials or some of these materials or one of these materials may constitute the first material. The portions may be solid portions fitted or disposed on a structure intended to support them.

Alternatively, the felloe 11 may have an interrupted or discontinuous shape, in particular an interrupted annular shape or a discontinuous annular shape.

Advantageously, the inertial element is monobloc. However, as an alternative, the inertial element may be formed by an assembly of multiple elements.

The hairspring 21 is preferably made from a paramagnetic or diamagnetic material having an electrical resistivity of greater than 20 μΩ×cm. As an alternative or in addition, the hairspring 21 has a collet 22 and/or a bridle 25 made from paramagnetic or diamagnetic material, in particular titanium or titanium alloy, having an electrical resistivity of greater than 20 μΩ×cm.

The oscillator 2 also comprises the inertial element staff 23. The inertial element staff 23 is preferably made from paramagnetic or diamagnetic material, in particular ceramic, for example zirconia, or paramagnetic steel or surface-hardened paramagnetic steel or coated paramagnetic steel.

As an alternative or in addition, the inertial element staff 23 advantageously does not have a bearing flange for the inertial element 1. Such a flange is usually provided on the inertial element staff to form a stop for stopping the inertial element relative to the staff during the assembly, in particular during the driving, of the inertial element on the staff.

The oscillator 2 further comprises a plate 24, in particular a double plate 24, made of or comprising the first material. The plate 24 is advantageously fitted on the staff 23 of the inertial element, in particular by driving.

As an alternative to the traditional oscillator described above with reference to FIG. 1, the oscillator may comprise an inertial element mounted on an elastically deformable structure that makes it possible for the inertial element to pivot with respect to a frame via elastic deformation of the elastically deformable structure.

Apart from the inertial element 1 described above and/or the oscillator 2 described above, the regulating system 100 comprises an escapement system 3 comprising one or more escapement components 31, 32, in particular an escapement wheel 31 and a pallet 32.

The escapement wheel 31 preferably comprises a plate 312 and a staff 311. The staff 311 is housed, in particular driven, in the plate 312 and makes it possible to pivot the escapement wheel 31 on the frame of the timepiece movement. The staff 311 is advantageously made from paramagnetic or diamagnetic material, in particular ceramic, for example zirconia, or paramagnetic steel or surface-hardened paramagnetic steel or coated paramagnetic steel or Phynox. The plate 312 is advantageously made from paramagnetic or diamagnetic material, in particular CuAl7Si2 or CuNi15Sn8 or lead-free brass CuZn21Si3P or NiP or titanium or titanium alloy or Co40Cr20Ni16Mo7 (Phynox) or ceramic, such as ZrO₂ or Al₂O₃, or silicon or ruby or glass.

The pallet 32 preferably comprises a plate 322 and a staff 321. The staff 321 is housed, in particular driven, in the plate 322 and makes it possible to pivot the pallet 32 on the frame of the timepiece movement. The staff 321 is advantageously made from paramagnetic or diamagnetic material, in particular ceramic, for example zirconia, or paramagnetic steel or surface-hardened paramagnetic steel or coated paramagnetic steel or Phynox. The plate 322 is advantageously made from paramagnetic or diamagnetic material, in particular CuAl7Si2 or CuNi15Sn8 or lead-free brass CuZn21Si3P or NiP or titanium or titanium alloy or Co40Cr20Ni16Mo7 (Phynox) or ceramic, such as ZrO₂ or Al₂O₃, or silicon or ruby or glass.

The solutions described above were compared in two configurations. A first configuration aims to obtain little residual effect after exposure to intense magnetic fields (2 T or 20 000 G and above). This first configuration consists in a movement (paramagnetic hairspring, balance wheel made of CuBe, that is to say copper-beryllium alloy, in particular a copper-beryllium alloy with 2% beryllium), the three staffs of the regulating system (balance staff, pallet arbor, escapement pinion) of which are made from paramagnetic or diamagnetic materials, in this instance from zirconia, Phynox and Phynox, respectively. For such a first configuration, it was noted that stoppage under a field typically occurs with a magnetic field having an intensity of 20 000 G, this being exceptional and considerably higher than the field intensity mentioned in the prior art documents (in particular in documents CH716862 and EP2979139 and in the standards, as seen above). In a second configuration, the use of a balance wheel made of lead-free brass, for example CuZn21Si3P (so called “Ecobrass” according to one of the solutions described above as substitution for a balance wheel made of CuBe according to the first configuration) also makes it possible to increase the limit value for the intensity of the magnetic field causing the stoppage of the movement by more than 60% (to above 35 000 G), as described in detail below. The applicant's studies tend to demonstrate that this unexpected effect can be explained by a reduction in the dissipation of energy via eddy currents induced by the movement of the balance wheel in the magnetic field, the lead-free brass “Ecobrass” exhibiting an electrical resistivity at least twice as high as that of CuBe. The use of a material with an even higher electrical resistivity, such as NiP, silicon, ceramic (zirconia and others) or glass should enable even higher stoppage thresholds to be reached. However, the stoppage threshold in a magnetic field does not evolve linearly with electrical resistivity. The behaviour will depend, among other things, on the configuration (and in particular on the materials used for the other components, and/or the possible presence of components allowing the generation of eddy currents on the balance wheel, etc), and on the geometry of the balance wheel (continuous felloe or discontinuous felloe). Surprisingly and unexpectedly, the increase in the stoppage threshold under a magnetic field is very significant when the resistivity of a metallic material is increased. An increase in resistivity of several orders of magnitude (by using semi-conducting or insulating materials in particular) is likely to increase the stoppage threshold under field conditions even further, but not proportionally.

Performance measurements for stoppage under a field were taken using movements provided with diverse component variants in the escapement and the oscillator (staffs, balance wheel) in order to analyze in particular the influence of the use of a balance wheel made of lead-free brass.

As it was noted that the resistance to stoppage under a field of a first movement configuration provided with “amagnetic” staffs, in particular for the first configuration, exceeds 15 000 G, the measurements consisted in determining the effective intensity at which stoppage under a field occurs using a superconducting electromagnet making it possible to reach magnetic field intensities of about 10 T (100 000 G).

### Configurations Tested

The tests concern two movement configurations, each tested on three parts (movements with dial and hands) (table 1). The movements of the two configurations comprise a paramagnetic hairspring made of NbZr alloy, pallet and escapement wheel plates made of paramagnetic NiP, a plate of the balance wheel made of lead-free brass “Ecobrass”. They also comprise the automatic winder, the spacer and the dial (with a base made of brass), and hands.

TABLE 1
Configurations tested (materials constituting different components).

| | Balance | Balance | Pallet | Escapement |
|---|---|---|---|---|
| Type | staff | wheel | arbor | pinion |
| CuBe balance wheel | Zirconia | Series (CuBe) | Phynox | Phynox |
| (first configuration) | | | | |
| Ecobrass balance | Zirconia | Lead-free | Phynox | Phynox |
| wheel (second | | brass | | |
| configuration) | | “Ecobrass” | | |

Taking the first configuration as a starting point, what was involved was evaluating the potential influence of substituting a balance wheel made of CuBe for a balance wheel made of lead-free brass “Ecobrass”.

### Protocol

The measurements were taken with a superconducting electromagnet from Oxford Instruments for applying a magnetic field of up to 12 T (120 000 G) with a homogeneity of the field of <±2%. The temperature of the working area is 20±2° C.

The superconducting electromagnets making it possible to reach field intensities of greater than 15 000 G have the drawback of not giving visual access to the sample.

The stoppage under the field was therefore detected by state captures at different intensity levels of the field:
Before exposure to the magnetic field, the piece is wound to an optimum winding state (0.5 turns) and an initial state capture h0 is taken (starting operation of the movement at 00h00 in parallel with a reference chronograph H0). The initial state is considered to be E0=h0−H0=0.
After exposure to a given intensity of the magnetic field, in particular at least after 20 minutes of functioning under the field, a second state capture for the piece h1 and for the reference chronograph H1 (placed outside of the magnetic field) is taken, the state being

$$E 1 = h 1 - H 1.$$

The stoppage detection criterion under consideration is based on the state E1:

It is considered that there is no stoppage under the field if E1>−2 min, considering ±1 minute of uncertainty for each state capture associated with handling and readings, and assuming that a strong rate drift under the field has only a negligible impact on these state captures (considering the rate under the field of ±5 000 seconds per day, the drift over 30 minutes of measurement is approximately 100 s). In practice, it was noted that the signature of a stoppage under the field is clear and unequivocal. Specifically, the state differences measured are grouped into two populations:
one centered around 0 (values between 0 and −2 min, mean and standard deviation of −0.2±0.5 min over 20 measurements) corresponding to no stoppage, and
the other centered around −20 min (values of between −19 and −31 minutes, mean and standard deviation of −20.5±6.0 min over 11 measurements) corresponding to stoppage under the field.

This method means that it is necessary to perform successive exposures between different plateaus at different field intensities. An initial field of 2 T (20 000 G) is applied, and then the intensity is increased gradually by 0.25 T or 0.5 T (2500 G or 5000 G) with stabilization in the maximum field for at least 3 minutes. The measurements are taken simultaneously over multiple movements.

### Results

First configuration with balance wheel made of CuBe:

The summary of the measurements for the first configuration clearly shows that the stoppage under the field occurs between 2.25 T and 2.50 T (between 22 500 G and 25 000 G).

Second configuration with balance wheel made of lead-free brass “Ecobrass”:
The sole stoppage in this configuration was noted after exposure to 4 T. The successful performance between 3.5 T and 4 T (35 000 G to 40 000 G) clearly shows that the balance wheel made of lead-free brass “Ecobrass”, in particular the balance wheel/plate pair made of lead-free brass “Ecobrass”, affords a very significant improvement over the first configuration.

Therefore, an additional improvement of approximately 60% in the limit magnetic field intensity is obtained with a balance wheel made of lead-free brass “Ecobrass” when there are three amagnetic staffs (balance staff, pallet arbor, escapement pinion) in this test configuration.

When only the balance staff is made of zirconia and the two other staffs are made of standard material (lead-free steel Finemac), substituting the balance wheel made of CuBe for a balance wheel made of lead-free brass “Ecobrass” makes it possible to double the intensity of the magnetic field that stops the movement, but from a lower magnetic field intensity value than that measured for the first configuration in table 1 that was described above. An improvement of approximately a factor of two in terms of stoppage under a magnetic field is therefore obtained in this case.

As concerns the residual daily rate (variation in the daily rate following the application of the magnetic field), a residual rate of approximately 1 second per day was measured (this is within the measurement error) after exposure at 100 000 G. The performance is excellent in this case, too.

The results show that it is very advantageous to combine the use of favorable geometries and paramagnetic or diamagnetic materials for the hairspring and for the staffs, in particular the staffs of the regulator (balance wheel, pallet, escapement wheel), with a particular material for the balance wheel and its plate. The effect of changing the material of the balance wheel is unexpected and surprising. A clue is given by the fact that the lead-free brass has greater resistivity than the CuBe commonly used for balance wheels and plates.

This is because a conductive component rotating in a magnetic field, such as a balance wheel-hairspring oscillator, is the recipient of induced currents, referred to as eddy currents.

The power dissipated in the form of eddy currents, by unit of volume, is given by the expression

$$p = \frac{{π}^{2}}{6} \times \frac{{e}^{2} {B}_{max}^{2} {f}^{2}}{{ρ}_{e}} ,$$

where f is the frequency of the magnetic field variation sinusoid and Bₘₐₓ is the amplitude of the sinusoidal field, ρₑ is the electrical resistivity of the material, e is the thickness (measured perpendicularly to B). Bₘₐₓ should be considered to be the amplitude of the variable part of the field, which will generate an electrical field. The total power is P=p×V, where V is the volume subject to the eddy currents.

An estimation indicates that, for an external magnetic field of 1 T applied to a timepiece having a balance wheel with a continuous felloe made of CuBe (first configuration), the losses via eddy currents in a regulating system set to run at 4 Hz are greater than half of the power available at the escapement wheel. For complex oscillator geometries, only finite element analysis can provide exact values. However, this does not change the means necessary for limiting the losses due to eddy currents as much as possible: the equation above suggests, for the felloe and if possible for the arms of the balance wheel and similarly for the plate, the use of a paramagnetic or diamagnetic material with as high an electrical resistivity as possible—for example ceramic, glass (Zerodur) or undoped silicon. However, the results obtained surprisingly show that the use of a conductive but more resistive material already makes it possible to make a substantial improvement, in particular for a continuous felloe as represented on FIGS. 1 and 2.

### Choice of Materials

As mentioned above, the dissipation effect linked to the generation of eddy currents is inversely proportional to the electrical resistance of the component and contributes to adversely affecting the performance of the regulating system in a magnetic field. It therefore appears to be possible to eliminate or at least limit this loss by utilizing a material with high electrical resistivity.

The lead-free brass, such as for example the alloy CuZn21Si3P (also known as “Ecobrass”) has the advantage over copper beryllium (CuBe) by having a resistivity that is approximately 2 to 3 times higher (table 2) while retaining a comparable mass per unit volume (and therefore a comparable balance wheel inertia for the same dimensions of this component).

It is therefore possible to expect that the energy loss to which the regulating system is subject under a magnetic field will be reduced by a factor of 2 to 3 with utilization of lead-free brass “Ecobrass” in relation to CuBe. The results show that this effect is proved as concerns the intensity of stoppage under a moving field.

TABLE 2
Comparison of masses per unit volume and electrical
resistivities of different materials.

| | | Mass per | Electrical |
|---|---|---|---|
| | | unit volume | resistivity |
| Material | State | [g × cm⁻³] | ρ [μΩ × cm] |
| Copper | After | 8.4 | 6-8 |
| beryllium | hardening | | (conductivity |
| (CuBe2) | | | 13-16 MS/m) |
| AL7 (CuAl7Si2) | | 7.7 | ~20 |
| | | | (conductivity |
| | | | 5 MS/m) |
| Ecobrass | | 8.3 | ~22 |
| (CuZn21Si3P) | | | (conductivity |
| | | | 4.5 MS/m) |
| Toughmet | | 8.9 | ~25 |
| (CuNi15Sn8) | | | (conductivity |
| | | | 4 MS/m) |
| NiP | 10% P | 8.0 | 100 |
| Titanium | Grade 5 | 4.5 | 170 |
| undoped Si | — | 2.3 | 6.4 10¹⁰ |
| Al2O3 | — | 3.8 | 10¹⁵ |
| Glass (Zerodur) | — | 2.5 | 2.6 10¹⁵ |
| ZrO2 | — | 5.9 | 10²³ |

Table 2 also shows the advantage of considering other conductive materials, or even semiconductor materials or insulators, for producing at least the felloe of the balance wheel or the inertial element. In general, it is estimated that the conductive materials exhibit an electrical resistivity of between 1 and 10³ μΩ×cm, the semiconductor materials exhibit an electrical resistivity of between 10³ and 10¹³ μΩ×cm and the insulators exhibit an electrical resistivity above 10¹³ μΩ×cm (conversion factor 1 Ω×m=10^{8 μΩ}×cm).

In the materials used to produce the timepiece components of the movement, electrodeposited NiP, Si and zirconia ZrO2 thus appear to be particularly advantageous, notably for obtaining even better performance than that of components made of lead-free brass. In such a case, however, the use of low-resistivity metallic materials should be avoided, such as the use of gold segments deposited on a semiconductor or insulating material component to increase its inertia. In fact, such use is highly detrimental to the performance of the inertial element obtained under magnetic field conditions.

It may also be advantageous to use a felloe with an interrupted or discontinuous shape to limit dissipation via eddy currents, or to use a felloe comprising multiple portions made of different materials or comprising different materials, in particular with semiconductor materials or electrical insulators interposed between portions made of conductive materials.

It may for example be advantageous to use an annular felloe formed by portions or segments in the orthoradial direction that are made of or comprise different materials. As an alternative, it may be advantageous for the felloe to be formed by a succession of layers or portions of different materials (stacked in an axial direction parallel to that of the staff 23 of the balance wheel), for example a felloe produced by successive growths of layers of materials with different electrical resistivities, for example alternating layers of insulating and conductive materials. As an alternative, it may be advantageous for the felloe to be formed by a succession of layers or portions of different materials stacked in a radial direction with respect to the staff 23 of the balance wheel. As a further alternative, it may be advantageous for the felloe to be formed by a composite of different materials, in particular materials having different electrical resistivities, for example formed by a composite with an insulating ceramic matrix forming a continuous network, in which a metallic conductive material is infiltrated.

The studies and tests described above have notably made it possible to highlight the influence of the material of the balance wheel on the resistance to stoppage under a magnetic field of configurations with a balance staff made of zirconia, in line with its electrical properties. The use of a high-resistivity material appears to be key in obtaining very high values of stoppage under a field, and therefore even better performance in terms of resistance to magnetic fields.

Changing the material of a balance wheel with a continuous felloe to lead-free brass “Ecobrass”, which exhibits a resistivity which is double, or even triple (22 μΩ·cm), that of CuBe (6-8 μΩ·cm), thus enables a very significant improvement of 60% and 100%, respectively, in the two variants tested. The value of stoppage under a field obtained on a modified series caliber (comprising the three staffs of the regulator made of amagnetic-paramagnetic or diamagnetic-material, a balance wheel with a continuous felloe and a plate made of lead-free brass “Ecobrass”) is greater than 35 000 G, this being truly noteworthy. In addition, the use of a monometallic balance wheel provided with a continuous annular felloe, made in one piece and from the same material, as illustrated in FIGS. 1 and 2, makes it possible to take advantage of the usual means of manufacture, balancing and assembly, without having to manage the complex machining or balancing associated with a balance wheel with a discontinuous felloe or with a cut felloe or with a bi-metallic felloe. The choice of a metal material with a higher electrical resistivity, in particular a resistivity greater than 20 μΩ×cm, in particular lead-free brass, for example CuZn21Si3P lead-free brass, for a monometallic balance wheel with a continuous felloe makes it possible, surprisingly, to very significantly improve the behaviour of the timepiece movement under a magnetic field, by reducing eddy currents.

Changing the material of the felloe to an even less conductive (more resistive) material, such as NiP, silicon, ceramic, or glass, is envisaged in order to obtain timepieces insensitive to very high magnetic field intensities from the point of view of stoppage under a field.

As a consequence of the solutions described above, according to the invention, the oscillator 2 preferably comprises components arranged and/or configured such that the oscillator and/or the movement and/or the timepiece have/has a magnetic field intensity value at which stoppage occurs of greater than or equal to 20 000 G or greater than or equal to 35 000 G.

Similarly, according to the invention, the regulating system 100 preferably comprises components arranged and/or configured such that the regulating system and/or the movement and/or the timepiece have/has a magnetic field intensity value at which stoppage occurs of greater than or equal to 20 000 G or greater than or equal to 35 000 G.

Similarly, according to the invention, the movement 200 preferably comprises components arranged and/or configured such that the movement has a magnetic field intensity value at which stoppage occurs of greater than or equal to 20 000 G or greater than or equal to 35 000 G.

Similarly, according to the invention, the timepiece 300 preferably comprises components arranged and/or configured such that the timepiece has a magnetic field intensity value at which stoppage occurs of greater than or equal to 20 000 G or greater than or equal to 35 000 G. Advantageously, the timepiece does not comprise a magnetic screen (in particular made of mu-metal, of permalloy or of soft iron) enclosing the movement.

This magnetic field intensity value at which stoppage occurs is defined in accordance with the stoppage detection criterion associated with the protocol described above. In any case, this protocol is applied (with the needed modifications) either to the oscillator alone, or to the regulating system alone, or to the timepiece movement alone, or to the timepiece.

Thus, the inertial elements, oscillators or regulating systems described above can be used in a timepiece movement or in a timepiece in order to increase:
its resistance to magnetic fields, and/or
its stoppage magnetic field strength value.

Whatever the embodiment or the variant, the felloe may have the same or substantially the same cross-sectional geometry (in a plane passing through the balance wheel pivot axis) regardless of the location of the felloe under consideration. For example, the felloe may only have variations in this cross-section at the level of means for adjusting the unbalance and/or the inertia, such as:
tapped holes extending radially (relative to the axis of the balance wheel) through the felloe and intended to receive adjustment screws, and/or
studs fixed to the felloe, extending radially (relative to the axis of the balance wheel) and intended to receive adjusting nuts.

Alternatively, the felloe may have no means for adjusting the unbalance and/or inertia and have the same or substantially the same cross-sectional geometry wherever the felloe is located.

Whatever the embodiment or the variant, the felloe can be contained between:
a first cylinder of smaller radius R containing the entire balance wheel, and
a second cylinder (coaxial with the first cylinder) with a radius greater than 0.9×R.

In particular, the annular part of the felloe, excluding variations in cross-section at the level of means for adjusting the unbalance and/or inertia such as steps or blom studs or studs, can be contained between:
a first cylinder of smaller radius R containing the entire balance wheel, and
a second cylinder (coaxial with the first cylinder) with a radius greater than 0.9×R.

Whatever the embodiment or the variant, the felloe can make up at least 85% of the balance wheel's moment of inertia about its pivot axis.

In particular, the annular part of the felloe, excluding variations in cross-section at the level of means for adjusting the unbalance and/or the inertia such as steps or blom studs or studs, and excluding the means for adjusting the unbalance and/or the inertia, can constitute at least 85% of the moment of inertia of the balance wheel about its pivot axis.

Whatever the embodiment or the variant, the balance wheel preferably has a structure comprising exclusively:
a felloe, and
a hub, and
arms for mechanically connecting the felloe to the hub, and
optionally, means for adjusting the unbalance and/or the inertia of the
   balance wheel.

1. An inertial element for a timepiece movement, the inertial element comprising a felloe comprising a first material:
which is paramagnetic or diamagnetic, and
which has an electrical resistivity of greater than 15 μΩ×cm.

2. The inertial element as claimed in claim 1, wherein the first material is a metallic material and has an electrical resistivity of less than 1,000 μΩ×cm.

3. The inertial element as claimed in claim 1, wherein the first material is:
a conductive material having an electrical resistivity of between 100 μΩ×cm and 10³ μΩ×cm, or
a semiconductor material having an electrical resistivity of between 10³ μΩ×cm and 10¹³μΩ×cm, or
an insulating material having an electrical resistivity of greater than 10¹³ μΩ×cm.

4. The inertial element as claimed in claim 1, wherein the inertial element comprises arms or a support connected to the felloe, the arms or the support comprising the first material.

5. The inertial element as claimed in claim 1, wherein the inertial element comprises a hub connected to arms or to a support, the hub comprising the first material.

6. The inertial element as claimed in claim 4, wherein the inertial element comprises a hub connected to the arms or to the support, the hub comprising the first material.

7. The inertial element as claimed in claim 1, wherein the first material is:
CuAl7Si2, or
CuNi15Sn8, or
lead-free brass, or
NiP, or
titanium or titanium alloy, or
Co40Cr20Ni16Mo7, or
ceramic, or
silicon, or
ruby, or
glass.

8. The inertial element as claimed in claim 1, wherein the felloe has a continuous shape, in particular a continuous annular shape.

9. The inertial element as claimed in claim 1, wherein the inertial element comprises multiple portions made with different materials.

10. The inertial element as claimed in claim 1, wherein the inertial element is monobloc.

11. An oscillator comprising:
an inertial element as claimed in claim 1, and
another element,
wherein the other element is:
a paramagnetic or diamagnetic hairspring made from a material having an electrical resistivity of greater than 20 μΩ×cm, and/or
a hairspring having a paramagnetic or diamagnetic collet and/or bridle made from a material having an electrical resistivity of greater than 20 μΩ×cm, and/or
an inertial element staff made of paramagnetic or diamagnetic material, or paramagnetic steel or surface-hardened paramagnetic steel or coated paramagnetic steel, and/or
an inertial element staff that does not have a bearing flange for the inertial element, and/or
a plate comprising the first material.

12. A regulating system, comprising:
an inertial element as claimed in claim 1, and
an escapement system,
wherein the escapement system comprises at least one escapement component comprising:
a staff made of paramagnetic or diamagnetic material, or paramagnetic steel or surface-hardened paramagnetic steel or coated paramagnetic steel, and/or
a plate made of paramagnetic or diamagnetic material.

13. A regulating system, comprising:
an inertial element and/or an oscillator, and
an escapement system,
wherein the escapement system comprises at least one escapement component comprising:
a staff made of paramagnetic or diamagnetic material, or paramagnetic steel or surface-hardened paramagnetic steel or coated paramagnetic steel, and/or
a plate made of paramagnetic or diamagnetic material.

14. A timepiece movement comprising the regulating system as claimed in claim 13, wherein the inertial element:
increases a resistance to magnetic fields of the timepiece movement, and/or
increases a stoppage of magnetic field strength value of the timepiece movement.

15. A timepiece movement comprising an inertial element as claimed in claim 1.

16. The timepiece movement, comprising:
an inertial element, and/or
an oscillator, and/or
a regulating system,
the components of the timepiece movement and/or of the inertial element are arranged and/or configured so that the movement has a magnetic field intensity value at which stoppage occurs of greater than or equal to 35,000 G.

17. A timepiece comprising a timepiece movement as claimed in claim 15.

18. A timepiece comprising the timepiece movement as claimed in claim 16.

19. The inertial element as claimed in claim 1, which is a balance wheel.

20. The inertial element as claimed in claim 1, wherein the first material has an electrical resistivity of greater than 20 μΩ×cm.
